(19) United States
(12) Patent Application Publication
(10) Pub. No.: US 2003/0091384 A1
(43) Pub. Date: May 15, 2003

(54) Connection apparatus for connecting prefabricated type panels

(76) Inventor: Mun-Young Jo, Daegu (KR)

Correspondence Address: JACOBSON HOLMAN PLLC, 400 SEVENTH STREET N.W., SUITE 600, WASHINGTON, DC, 20004, US

(21) Appl. No.: 10/156,193

(22) Filed: May 29, 2002

(30) Foreign Application Priority Data
Nov. 9, 2001 (KR) 2001-69696

(51) Int. Cl. F16B 7/04

(52) U.S. Cl. 403/350

(57) ABSTRACT

The connection apparatus for connecting prefabricated type panels includes a casing fixedly installed in an edge portion of a prefabricated panel in such a manner that a first installation portion is formed in the center of the same in a longitudinal direction, and a second installation portion is formed in a side surface and is formed alternately with respect to the first installation portion; an engaging member in which a helical gear portion is formed in the center portion of the same, a upside down L-shaped guide groove is formed in the helical gear portion, and an engaging expansion portion having an upper slanted surface is formed in a front end of the same, so that said engaging member is installed in the first installation portion of the casing in a rotatable and movable manner in such a manner that two neighboring prefabricated type panels, a prefabricated type panel and upper horizontal member, and a prefabricated type panel and lower horizontal member are closely contacted each other; an operation member in which a driving helical gear portion engaged with a helical gear portion of the engaging member is formed, and a surrounding groove is formed in a rear end portion, wherein said operation member is rotatable in a second installation portion of the casing; a first pin which is inserted into a first hole communicating with the first installation portion of the casing and includes a front end inserted into the guide groove of the engaging member; and a second pin which is inserted into a second hole communicating with the second installation portion of the casing.

### BACKGROUND OF THE INVENTION

1. Field of the Invention

The present invention relates to a connection apparatus for connecting prefabricated type panels, and in particular to a connection apparatus for connecting prefabricated type panels which is capable of stably connecting a prefabricated type panel with another panel positioned in an upper, lower, right or left portion and upper and lower horizontal bars.

2. Description of the Background Art

A prefabricated type panel is constituted in such a manner that two sheets of plate members are distanced in parallel, an edge member is installed in a circumferential edge portion of the plate member, and a flat shaped insulating member formed of a foam resin, etc. is formed between two sheets of plate members.

Since the above prefabricated type panel is generally connected each other when building a prefabricated type building, the prefabricated type panel is formed in a square shape. One edge member is formed in a concave shape in one of both sides of the same, and another edge member is formed in a convex shape in one of both sides of the same. The edge members positioned in the upper and lower portions are formed in a concave or convex shape in order to correspond with the shapes of the upper horizontal bar and the lower horizontal bar.

Therefore, in the conventional art, in order to stably connect a plurality of prefabricated type panels, the edge member of the concave of the prefabricated type panel is inserted into the edge member of the concave shape of the neighboring prefabricated type panel, and the upper horizontal bar and lower horizontal bar are installed in the upper and lower portions of the prefabricated type panel.

However, in the conventional art, when installing a plurality of prefabricated type panels, since a prefabricated type structure in which the concave shaped edge member and convex shaped edge member are connected each other is built, a plurality of prefabricated type panels may not be stably connected each other. Therefore, the upper horizontal bar and lower horizontal bar installed in the upper and lower portions of the prefabricated type panel may not be stably connected, so that the stability of the structure is significantly decreased.

In addition, in the conventional art, since the prefabricated type panels are simply connected each other, a certain gap may be formed between each connected portions, so that an anti-noise and heatproof characteristic of a building is decreased.

### SUMMARY OF THE INVENTION

Accordingly, it is an object of the present invention to provide a connection apparatus for connecting prefabricated type panels which overcomes the problems encountered in the conventional baby carriage.

It is another object of the present invention to provide a connection apparatus for connecting prefabricated type panels which is capable of stably connecting a prefabricated type panel with another panel positioned in an upper, lower, left or right portion of the same and upper and lower horizontal bars by closely and mechanically contacting each connected portion of a surrounding surface of a prefabricated type panel.

In order to achieve the above objects, there is provided a connection apparatus for connecting prefabricated type panels which is installed in upper, lower, left and right edge portions of an interior of a prefabricated type panel in multiple numbers for thereby connecting prefabricated type panels and the prefabricated type panels and upper horizontal member and lower horizontal member. The connection apparatus for connecting prefabricated type panels includes a casing fixedly installed in an edge portion of a prefabricated panel in such a manner that a first installation portion is formed in the center of the same in a longitudinal direction, and a second installation portion is formed in a side surface and is formed alternately with respect to the first installation portion; an engaging member in which a helical gear portion is formed in the center portion of the same, a upside down L-shaped guide groove is formed in the helical gear portion, and an engaging expansion portion having an upper slanted surface is formed in a front end of the same, so that the engaging member is installed in the first installation portion of the casing in a rotatable and movable manner in such a manner that two neighboring prefabricated type panels, a prefabricated type panel and upper horizontal member, and a prefabricated type panel and lower horizontal member are closely contacted each other; an operation member in which a driving helical gear portion engaged with a helical gear portion of the engaging member is formed, and a surrounding groove is formed in a rear end portion, wherein the operation member is rotatable in a second installation portion of the casing; a first pin which is inserted into a first hole communicating with the first installation portion of the casing and includes a front end inserted into the guide groove of the engaging member; and a second pin which is inserted into a second hole communicating with the second installation portion of the casing and includes a front end inserted into a surrounding groove of the operation member.

### BRIEF DESCRIPTION OF THE DRAWINGS

The present invention will become better understood with reference to the accompanying drawings which are given only by way of illustration and thus are not limitative of the present invention, wherein;

FIG. 1 is a front view illustrating a prefabricated type wall to which a connection apparatus for connecting prefabricated type panels according to the present invention is adapted;

FIG. 2 is a cross-sectional view taken along line A-A of FIG. 1;

FIG. 3 is a perspective view illustrating a state of use of a connection apparatus for connecting prefabricated type panels according to the present invention; and

FIG. 4 is a disassembled perspective view illustrating a connection apparatus for connecting prefabricated type panels according to the present invention.

### DETAILED DESCRIPTION OF THE PREFERRED EMBODIMENTS

The preferred embodiments of the present invention will be explained with reference to the accompanying drawings.

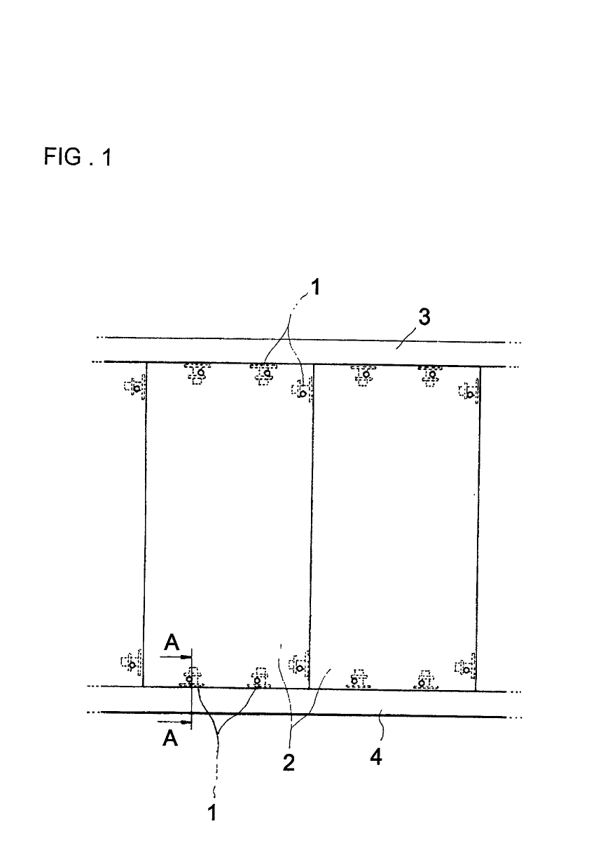

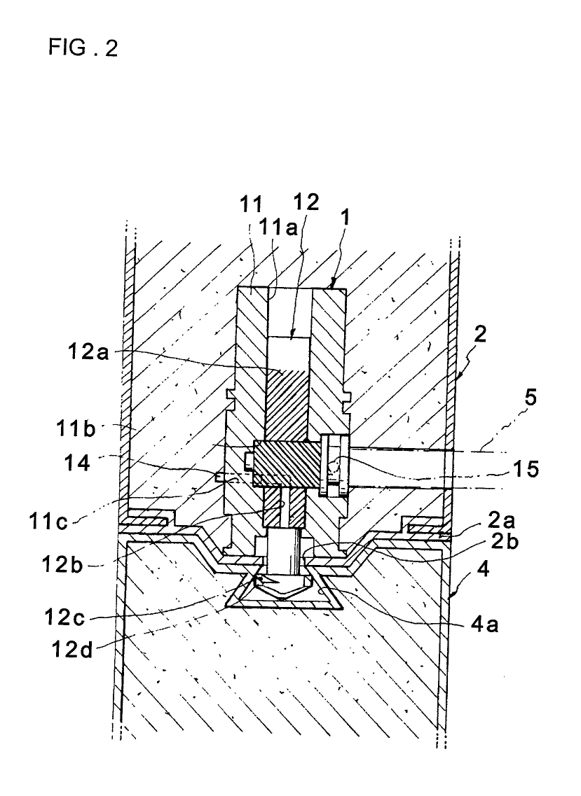

FIGS. 1 and 2 are views illustrating a connection apparatus for connecting prefabricated type panels according to the present invention. In the drawings, reference numeral 1 represents a connection apparatus for connecting the prefabricated type panels 2 each other and the prefabricated type panels 2 with an upper horizontal bar 3 and a lower horizontal bar 4.

The connection apparatus 1 is installed in the upper, lower, left and right edge surfaces of the interior of the panel 2 in multiple numbers. The connection apparatus 1 is fixedly installed in the edge member 2a of the panel 2. An engaging member 12 and an operation member 13 are engaged with a casing 11 in a crossed method. A first pin 14 is installed into a side surface of the engaging member 12. A second pin 15 is inserted into a side surface of the operation member 13.

Here, in the casing 11, a first installation portion 11a in which the engaging member 12 is installed is formed in the center portion in a longitudinal direction. A second installation portion 11b in which the operation member 13 is installed is formed in a side surface in such a manner that the second installation portion 11b is formed alternately with respect to the first installation portion 11a. The second installation portion 11b is formed in an edge surface of the panel 2 in multiple numbers.

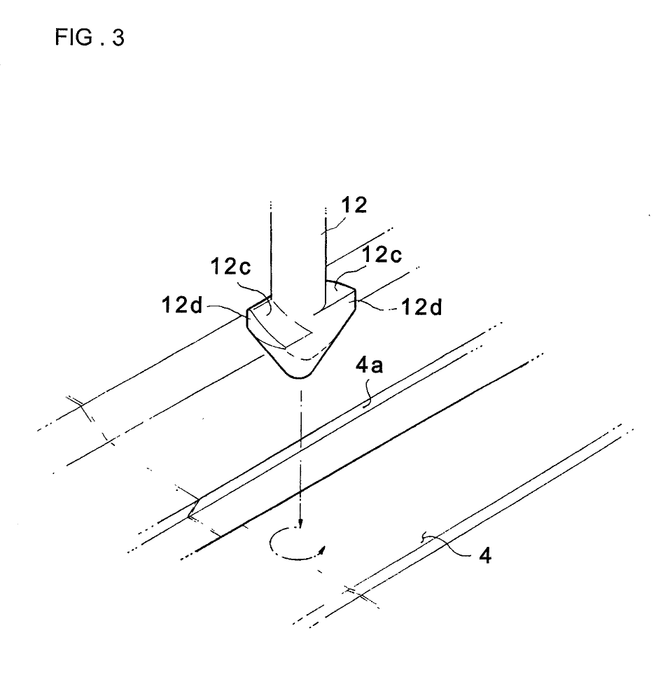

A helical gear portion 12a is formed in the center of the engaging member 12. The helical gear portion 12a includes a upside down L-shaped guide groove 12b and includes a front end in which an engaging expansion portion 12d having a upper side slanted surface 12c is formed. The engaging member 12 is installed in such a manner that the engaging member 12 is rotatable with respect to the first installation portion 11a of the casing 11. As shown in FIG. 3, the engaging member 12 is forwardly moved and rotated by the rotation operation of the operation member 13 for thereby closely contacting two panels 2, the panel 2 and the upper horizontal bar 3, and the panel 2 and the lower horizontal bar 4, respectively.

The operation member 13 includes a driving helical gear portion 13a engaged with the helical gear portion 12a of the engaging member 12. A surrounding groove 13b is formed in a rear end portion of the same, so that the operation member 13 is rotatable with respect to the second installation portion 11b of the casing 11. A hexagonal groove 13c is formed in a rear end surface of the operation member so that a hexagonal wrench 5 rotates the operation member 13.

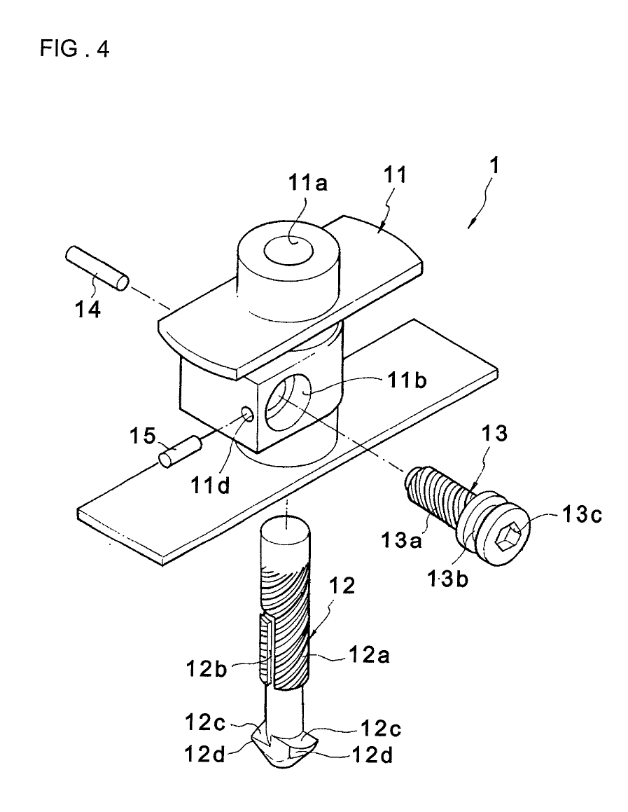

As shown in FIGS. 2 and 4, the first pin 14 is inserted into a first hole 11c formed in the casing 11 for thereby communicating with the first installation portion 11a of the casing 11. Therefore, the end portion of the same is inserted into the guide groove 12b of the engaging member 12.

The second pin 15 is inserted into a second hole 1d formed in the casing 11 for thereby communicating with the second installation portion 11b of the casing 11. Therefore, the end portion of the same is inserted into the surrounding groove 13b of the operation member 13.

As shown in FIG. 2, the connection apparatus 1 according to the present invention is capable of connecting the panel 2 and the lower horizontal member 4, connecting the panels 2, and the panel 2 and the upper horizontal member, respectively. As shown in FIGS. 2 and 3, the engaging expansion portion 12d of the engaging member 12 passes through a through hole 2b formed in the edge member 2a of the panel 2 and may be inserted into an insertion groove 4a formed in the lower horizontal member 4 in the longitudinal direction.

The operation of the connection apparatus for connecting prefabricated panels according to the present invention will be explained with reference to the accompanying drawings.

In the connection apparatus 1 according to the present invention, the hexagonal wrench 1 is inserted into the hexagonal groove 13c of the operation member 13 through the side surface of the panel 2. When the operation member 13 is rotated, since the first pin 14 is inserted in the guide groove 12b of the engaging member 12, the engaging member 12 is moved linearly and passes through the through hole 2b formed in the edge member 2a of the panel 2 and is inserted into the insertion groove 4a formed in the lower horizontal member 4. The first pin 14 reaches at a bent portion of the guide groove 12b.

In the above state, the forward movement of the engaging member 12 is stopped by the first pin 14. When the operation member 13 is rotated more, the engaging member 12 is rotated.

The slanted surface 12c formed in the upper portion of the engaging expansion portion 12d of the engaging member 12 is positioned in the inner surface of the insertion groove 4a of the lower horizontal member 4, and the panel 2 and the lower horizontal member 4 are more closely contacted by the rotation of the slanted surface 12c.

When separating the panel 2 and the lower horizontal member 4, the operation member 13 is rotated in the reverse direction, and then the engaging member 12 is operated in the reverse sequence compared to the above-described engaging sequence. Therefore, the panel 2 is separated from the insertion groove 4a of the lower horizontal member 4 and is positioned in the casing 11 through the through hole 2b of the panel 2, so that the panel 2 and the lower horizontal member 4 are separated from each other.

Therefore, the connection apparatus for connecting prefabricated panels according to the present invention is capable of stably and closely connecting the panel and the panel, the panel and the upper horizontal member, and the panel and the lower horizontal member. In addition, it is possible to effectively seal the gaps formed in the connected portions by interposing a sealing member in each connected portion.

As described above, in the connection apparatus for connecting prefabricated panels, when the engaging member is moved linearly and then is rotated, the slanted surface formed in the front end portion of the engaging member is closely contacted with a neighboring panel and the inner surfaces of the insertion grooves of the neighboring upper and lower horizontal members, it is possible to stably and closely contact the panels, the panel and upper horizontal member and the panel and lower horizontal member based on the rotation of the slanted surface.

In addition, in the connection apparatus for connecting prefabricated panels according to the present invention, it is possible to significantly decrease the gaps formed in each connected portion between the panels, the panel and upper horizontal member, and the panel and lower horizontal member, so that a noise-proof and heatproof characteristics of a prefabricated type building is enhanced.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore total changes and modifications that fall within the meets and bounds of the claims, or equivalences of such meets and bounds are therefore intended to be embraced by the appended claims.

What is claimed is:

1. In a connection apparatus for connecting prefabricated type panels which is installed in upper, lower, left and right edge portions of an interior of a prefabricated type panel in multiple numbers for thereby connecting prefabricated type panels and the prefabricated type panels and upper horizontal member and lower horizontal member, respectively, a connection apparatus for connecting prefabricated type panels, comprising:
a casing fixedly installed in an edge portion of a prefabricated panel in such a manner that a first installation portion is formed in the center of the same in a longitudinal direction, and a second installation portion is formed in a side surface and is formed alternately with respect to the first installation portion;
an engaging member in which a helical gear portion is formed in the center portion of the same, a upside down L-shaped guide groove is formed in the helical gear portion, and an engaging expansion portion having an upper slanted surface is formed in a front end of the same, so that said engaging member is installed in the first installation portion of the casing in a rotatable and movable manner in such a manner that two neighboring prefabricated type panels, a prefabricated type panel and upper horizontal member, and a prefabricated type panel and lower horizontal member are closely contacted each other;
an operation member in which a driving helical gear portion engaged with a helical gear portion of the engaging member is formed, and a surrounding groove is formed in a rear end portion, wherein said operation member is rotatable in a second installation portion of the casing;
a first pin which is inserted into a first hole communicating with the first installation portion of the casing and includes a front end inserted into the guide groove of the engaging member; and
a second pin which is inserted into a second hole communicating with the second installation portion of the casing and includes a front end inserted into a surrounding groove of the operation member.
